(19) United States
(12) Patent Application Publication
(10) Pub. No.: US 2026/0210572 A1
(43) Pub. Date: Jul. 23, 2026

(54) COMPUTERIZED SYSTEMS AND METHODS FOR THERMOSTAT GEOFENCING AND TEMPERATURE SETPOINT MANAGEMENT

(71) Applicant: RESIDEO LLC, Golden Valley, MN (US)

(72) Inventors: Travis Read, Little Canada, MN (US); Christopher Jones; Jonathan Erbacher

(73) Assignee: RESIDEO LLC, Golden Valley, MN (US)

(21) Appl. No.: 19/141,543

(22) PCT Filed: Dec. 21, 2023
(86) PCT No.: PCT/US2023/085344

§ 371 Date: Jun. 20, 2025

Related U.S. Application Data
(60) Provisional application No. 63/476,969, filed on Dec. 23, 2022.

(51) Int. Cl. F24F 11/63; F24F 11/57; F24F 11/58; H04L 12/28

(52) U.S. Cl. CPC F24F 11/63; H04L 12/282; F24F 11/57; F24F 11/58

(57) ABSTRACT

Disclosed are systems and methods that provide a novel framework for a secure, geofenced-based control and management of a thermostat and/or an associated HV AC/baseboard climate system. Activities related to a status, cunent operation mode, temperature control and/or operation/temperature changes can be based on detected user presence/occupancy within a geofenced area that corresponds to the climate system. The disclosed framework can further or alternatively base control and/or management of the thermostat based on whether operational values (e.g., temperatures, for example) conelate with particular deviations from operational settings (e.g., setpoints, for example). Thus, the disclosed framework can enable an automated and/or dynamic operational control of a climate system based on geofenced and current and/or requested operational values.

### CROSS-REFERENCE TO RELATED APPLICATION

This application claims the benefit of, and priority to, U.S. Provisional Patent Application No. 63/476,969, filed Dec. 23, 2022, its entirety of which is incorporated herein by reference.

### FIELD OF THE DISCLOSURE

The present disclosure is generally related to a thermostat control system, and more particularly, to a decision intelligence (DI)-based computerized framework for thermostat geofencing and temperature setpoint management.

### BACKGROUND

Conventional thermostats for modern heating, cooling and ventilating (HVAC) systems and baseboard systems that are tasked with performing climate control for a location (e.g., a building, home, office, and the like, for example) do not have safeguards that control, prohibit and/or restrict unapproved and/or manually provided temperature changes. For example, if the parent occupants of a home leave the residence, and their children are home, there are currently no mechanisms for the parents to control whether the children can modify the temperature in the house.

### SUMMARY OF THE DISCLOSURE

Currently, a thermostat can be manually locked and unlocked. For example, when the parents leave the home, they can manually lock a keypad of the thermostat thereby restricting access to temperature controls. This operates against the very nature of the thermostat's operation, in that should a temperature change be need/desired, a dynamic and real-time, environmental-based approach should be applied; however, under conventional climate systems and thermostat mechanisms, such functionality is glaringly absent from the capabilities of such systems/devices.

According to some embodiments, the disclosed systems and methods provide a novel computerized framework that addresses such shortcomings in the art, and provides other features, inter alia, by providing and enabling geofencing technology to be applied and implemented via the operational modes and runtime of a thermostat and climate system (e.g., HVAC and/or baseboard systems, for example).

According to some embodiments, a geofence (or geo-fence, used interchangeably) involves a virtual perimeter for a real-world location. According to some embodiments, as discussed herein, a geofence can be dynamically generated (e.g., a radius around a point location, for example) or match a predefined set of boundaries (e.g., around a house, room, building, hallway, property, yard, and the like, for example). Accordingly, as understood by those of skill in the art, as discussed herein, use of a geofence (or geofencing) can involve the use of location-aware devices and/or sensors, that can be associated with, connected to and/or responsive to a location-based service (LBS) that monitors and determines when users enter, exit and/or remain within a geofence.

According to some embodiments, the disclosed framework can provide novel functionality for the control and/or management of a thermostat. As discussed herein, in some embodiments, a geofence can be applied and/or associated to a thermostat (and/or its associated HVAC/baseboard climate system), whereby the activity of the users respective to the geofence can dictate the operational modes and/or temperature settings of the thermostat. In some embodiments, at least one administrator user can be associated with the geofence, and when that user is determined to be outside the geofence, all modifications to existing thermostat/climate systems settings and modes must be pre-approved prior to being executed. In some embodiments, certain modifications to certain settings and/or modes may be analyzed respective to threshold deviations (or limits), and should such modifications (e.g., temperature changes) be within the thresholds, they may be permitted, which may further be dependent upon the administrator user's presence within the geofence, as discussed herein.

According to some embodiments, a method is disclosed for thermostat geofencing and temperature setpoint management. In accordance with some embodiments, the present disclosure provides a non-transitory computer-readable storage medium for carrying out the above-mentioned technical steps of the framework's functionality. The non-transitory computer-readable storage medium has tangibly stored thereon, or tangibly encoded thereon, computer readable instructions that when executed by a device cause at least one processor to perform a method for thermostat geofencing and temperature setpoint management.

In accordance with some embodiments, a system is provided that includes one or more processors and/or computing devices configured to provide functionality in accordance with such embodiments. In accordance with one or more embodiments, functionality is embodied in steps of a method performed by at least one computing device. In accordance with one or more embodiments, program code (or program logic) executed by a processor(s) of a computing device to implement functionality in accordance with one or more such embodiments is embodied in, by and/or on a non-transitory computer-readable medium.

### DESCRIPTIONS OF THE DRAWINGS

The features, and advantages of the disclosure will be apparent from the following description of embodiments as illustrated in the accompanying drawings, in which reference characters refer to the same parts throughout the various views. The drawings are not necessarily to scale, emphasis instead being placed upon illustrating principles of the disclosure:

FIG. 1 is a block diagram of an example configuration within which the systems and methods disclosed herein could be implemented according to some embodiments of the present disclosure;

FIG. 2 is a block diagram illustrating components of an exemplary system according to some embodiments of the present disclosure;

FIG. 3 illustrates an exemplary workflow according to some embodiments of the present disclosure;

FIG. 4 depicts an exemplary implementation of an architecture according to some embodiments of the present disclosure;

FIG. 5 depicts an exemplary implementation of an architecture according to some embodiments of the present disclosure; and

FIG. 6 is a block diagram illustrating a computing device showing an example of a client or server device used in various embodiments of the present disclosure.

### DETAILED DESCRIPTION

The present disclosure will now be described more fully hereinafter with reference to the accompanying drawings, which form a part hereof, and which show, by way of non-limiting illustration, certain example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

The present disclosure is described below with reference to block diagrams and operational illustrations of methods and devices. It is understood that each block of the block diagrams or operational illustrations, and combinations of blocks in the block diagrams or operational illustrations, can be implemented by means of analog or digital hardware and computer program instructions. These computer program instructions can be provided to a processor of a general purpose computer to alter its function as detailed herein, a special purpose computer, ASIC, or other programmable data processing apparatus, such that the instructions, which execute via the processor of the computer or other programmable data processing apparatus, implement the functions/acts specified in the block diagrams or operational block or blocks. In some alternate implementations, the functions/acts noted in the blocks can occur out of the order noted in the operational illustrations. For example, two blocks shown in succession can in fact be executed substantially concurrently or the blocks can sometimes be executed in the reverse order, depending upon the functionality/acts involved.

For the purposes of this disclosure a non-transitory computer readable medium (or computer-readable storage medium/media) stores computer data, which data can include computer program code (or computer-executable instructions) that is executable by a computer, in machine readable form. By way of example, and not limitation, a computer readable medium may include computer readable storage media, for tangible or fixed storage of data, or communication media for transient interpretation of code-containing signals. Computer readable storage media, as used herein, refers to physical or tangible storage (as opposed to signals) and includes without limitation volatile and non-volatile, removable and non-removable media implemented in any method or technology for the tangible storage of information such as computer-readable instructions, data structures, program modules or other data. Computer readable storage media includes, but is not limited to, RAM, ROM, EPROM, EEPROM, flash memory or other solid state memory technology, optical storage, cloud storage, magnetic storage devices, or any other physical or material medium which can be used to tangibly store the desired information or data or instructions and which can be accessed by a computer or processor.

For the purposes of this disclosure the term “server” should be understood to refer to a service point which provides processing, database, and communication facilities. By way of example, and not limitation, the term “server” can refer to a single, physical processor with associated communications and data storage and database facilities, or it can refer to a networked or clustered complex of processors and associated network and storage devices, as well as operating software and one or more database systems and application software that support the services provided by the server. Cloud servers are examples.

For the purposes of this disclosure a “network” should be understood to refer to a network that may couple devices so that communications may be exchanged, such as between a server and a client device or other types of devices, including between wireless devices coupled via a wireless network, for example. A network may also include mass storage, such as network attached storage (NAS), a storage area network (SAN), a content delivery network (CDN) or other forms of computer or machine-readable media, for example. A network may include the Internet, one or more local area networks (LANs), one or more wide area networks (WANs), wire-line type connections, wireless type connections, cellular or any combination thereof. Likewise, sub-networks, which may employ differing architectures or may be compliant or compatible with differing protocols, may interoperate within a larger network.

For purposes of this disclosure, a “wireless network” should be understood to couple client devices with a network. A wireless network may employ stand-alone ad-hoc networks, mesh networks, Wireless LAN (WLAN) networks, cellular networks, or the like. A wireless network may further employ a plurality of network access technologies, including Wi-Fi, Long Term Evolution (LTE), WLAN, Wireless Router mesh, or 2nd, 3rd, 4^{th} or 5^{th} generation (2G, 3G, 4G or 5G) cellular technology, mobile edge computing (MEC), Bluetooth, 802.11b/g/n, or the like. Network access technologies may enable wide area coverage for devices, such as client devices with varying degrees of mobility, for example.

In short, a wireless network may include virtually any type of wireless communication mechanism by which signals may be communicated between devices, such as a client device or a computing device, between or within a network, or the like.

A computing device may be capable of sending or receiving signals, such as via a wired or wireless network, or may be capable of processing or storing signals, such as in memory as physical memory states, and may, therefore, operate as a server. Thus, devices capable of operating as a server may include, as examples, dedicated rack-mounted servers, desktop computers, laptop computers, set top boxes, integrated devices combining various features, such as two or more features of the foregoing devices, or the like.

For purposes of this disclosure, a client (or user, entity, subscriber or customer) device may include a computing device capable of sending or receiving signals, such as via a wired or a wireless network. A client device may, for example, include a desktop computer or a portable device, such as a cellular telephone, a smart phone, a display pager, a radio frequency (RF) device, an infrared (IR) device a Near Field Communication (NFC) device, a Personal Digital Assistant (PDA), a handheld computer, a tablet computer, a phablet, a laptop computer, a set top box, a wearable computer, smart watch, an integrated or distributed device combining various features, such as features of the forgoing devices, or the like.

A client device may vary in terms of capabilities or features. Claimed subject matter is intended to cover a wide range of potential variations, such as a web-enabled client device or previously mentioned devices may include a high-resolution screen (HD or 4K for example), one or more physical or virtual keyboards, mass storage, one or more accelerometers, one or more gyroscopes, global positioning system (GPS) or other location-identifying type capability, or a display with a high degree of functionality, such as a touch-sensitive color 2D or 3D display, for example.

Certain embodiments and principles will be discussed in more detail with reference to the figures. According to some embodiments, the disclosed framework provides a novel framework that can enable automated control, security and/or fail-safes for the operation of a thermostat and/or HVAC/baseboard system of a location.

In some embodiments, as discussed herein, a location can refer to any type of definable and/or confined geographic and/or physical area for which an HVAC and/or baseboard climate system can be applied, such as, not limited to, a home, office, building, garage and the like.

For purposes of this disclosure, the disclosed framework can operate in connection with a thermostat(s) and/or HVAC, baseboard and/or any other type of known or to be known climate control system; therefore, for ease of explanation, reference throughout will be made pursuant to a “climate system” (or climate-control system), which should be understood to refer to any type of known or to be known heating, cooling and/or ventilation system for which a climate (e.g., temperature, for example) setting can be set, maintained, controlled and/or modified.

Accordingly, while the discussion herein will be in reference to a temperature setting of a climate system, it should not be construed as limiting, as any type of known or to be known setting (or attribute) associated with a location can be configured, managed and controlled according to the disclosed systems and methods without departing from the scope of the instant application. For example, such settings can be in reference to, but not limited to, humidity, lighting, energy consumption, gas usage, water usage, security settings (e.g., arm/disarm system), and the like, or some combination thereof. For example, as based on the discussion herein, a security system may be armed and/or disarmed based on whether particular users are determined to be located with a geofenced area associated with the location.

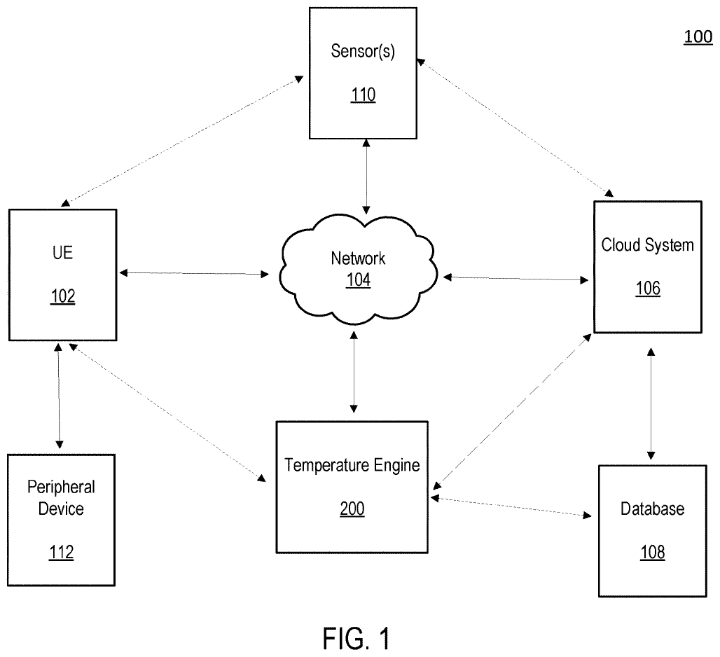

With reference to FIG. 1, system 100 is depicted which includes UE 102 (e.g., a client device, as mentioned above and discussed below in relation to FIG. 7), sensors 110, network 104, cloud system 106, database 108, temperature engine 200 and peripheral device 112. It should be understood that while system 100 is depicted as including such components, it should not be construed as limiting, as one of ordinary skill in the art would readily understand that varying numbers of UEs, peripheral devices, sensors, cloud systems, databases and networks can be utilized; however, for purposes of explanation, system 100 is discussed in relation to the example depiction in FIG. 1.

According to some embodiments, UE 102 can be any type of device, such as, but not limited to, a mobile phone, tablet, laptop, sensor, Internet of Things (IOT) device, autonomous machine, and any other device equipped with a cellular or wireless or wired transceiver. In some embodiments, UE 102 can be a device associated with an individual (or set of individuals) for which disclosed services are being provided. In some embodiments, UE 102 may correspond to a device of a HVAC or climate-control related entity (e.g., a HVAC provider, whereby the device can be and/or can have corresponding sensors 110, as discussed herein).

In some embodiments, peripheral device 112 can be connected to UE 102, and can be any type of peripheral device, such as, but not limited to, a wearable device (e.g., smart watch), printer, speaker, sensor, and the like. In some embodiments, peripheral device 112 can be any type of device that is connectable to UE 102 via any type of known or to be known pairing mechanism, including, but not limited to, Bluetooth™, Bluetooth Low Energy (BLE), NFC, and the like.

According to some embodiments, a sensors 110 can correspond to sensors associated with a location of system 100. In some embodiments, the sensors 110 can be associated with security sensors, such as, for example, cameras, glass break detectors, motion detectors, door and window contacts, heat and smoke detectors, carbon monoxide (CO2) detectors, passive infrared (PIR) sensors, and the like. In some embodiments, the sensors can be associated with devices associated with the location of system 100, such as, for example, lights, smart locks, garage doors, smart appliances (e.g., thermostat, refrigerator, television, personal assistants (e.g., Alexa®), Nest®), for example)), smart phones, smart watches or other wearables, tablets, personal computers, and the like, and some combination thereof. Thus, the sensors 110 can be, wholly or in part, part of an IoT sensor network. For example, the sensors 110 can include the sensors on UE 102 (e.g., smart phone) and/or peripheral device 112 (e.g., a paired smart watch).

In some embodiments, network 104 can be any type of network, such as, but not limited to, a wireless network, cellular network, the Internet, and the like (as discussed above). Network 104 facilitates connectivity of the components of system 100, as illustrated in FIG. 1.

According to some embodiments, cloud system 106 may be any type of cloud operating platform and/or network based system upon which applications, operations, and/or other forms of network resources may be located. For example, system 106 may be a service provider and/or network provider from where services and/or applications may be accessed, sourced or executed from. For example, system 106 can represent the cloud-based architecture associated with a temperature control system provider, which has associated network resources hosted on the internet or private network (e.g., network 104), which enables (via engine 200) the temperature management discussed herein.

In some embodiments, cloud system 106 may include a server(s) and/or a database of information which is accessible over network 104. In some embodiments, a database 108 of cloud system 106 may store a dataset of data and metadata associated with local and/or network information related to a user(s) of UE 102/device 112 and the UE 102/device 112, sensors 110, and the services and applications provided by cloud system 106 and/or temperature engine 200.

In some embodiments, for example, cloud system 106 can provide a private/proprietary climate management platform, whereby engine 200, discussed infra, corresponds to the novel functionality system 106 enables, hosts and provides to a network 104 and other devices/sensors/platforms operating thereon.

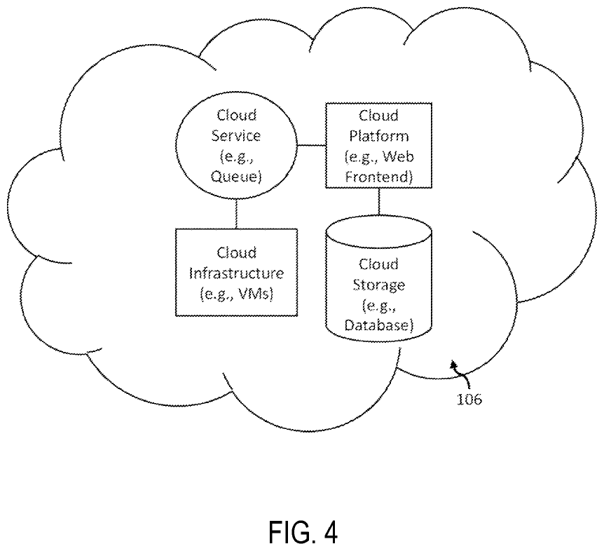

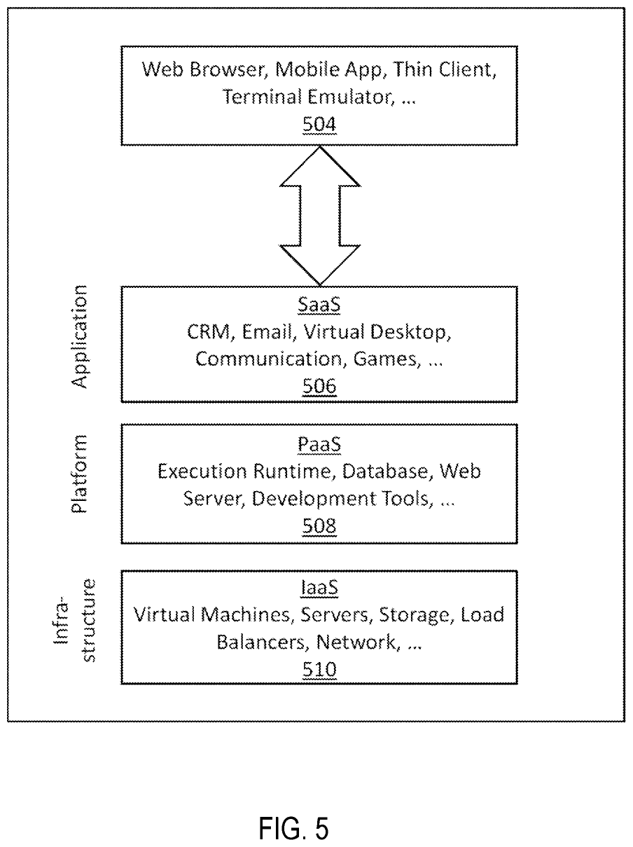

Turning to FIG. 4 and FIG. 5, in some embodiments, the exemplary computer-based systems/platforms, the exemplary computer-based devices, and/or the exemplary computer-based components of the present disclosure may be specifically configured to operate in a cloud computing/architecture 106 such as, but not limiting to: infrastructure a service (IaaS) 510, platform as a service (PaaS) 508, and/or software as a service (Saas) 506 using a web browser, mobile app, thin client, terminal emulator or other endpoint 504. FIG. 4 and FIG. 5 illustrate schematics of non-limiting implementations of the cloud computing/architecture(s) in which the exemplary computer-based systems for administrative customizations and control of network-hosted application program interfaces (APIs) of the present disclosure may be specifically configured to operate.

Turning back to FIG. 1, according to some embodiments, database 108 may correspond to a data storage for a platform (e.g., a network hosted platform, such as cloud system 106, as discussed supra), a plurality of platforms, and/or UE 102 and/or sensors 110. Database 108 may receive storage instructions/requests from, for example, engine 200 (and associated microservices), which may be in any type of known or to be known format, such as, for example, standard query language (SQL). According to some embodiments, database 108 may correspond to any type of known or to be known storage, for example, a memory or memory stack of a device, a distributed ledger of a distributed network (e.g., blockchain, for example), a look-up table (LUT), and/or any other type of secure data repository.

Temperature engine 200, as discussed above and further below in more detail, can include components for the disclosed functionality. According to some embodiments, temperature engine 200 may be a special purpose machine or processor, and can be hosted by a device on network 104, within cloud system 106 and/or on UE 102 (and/or peripheral device 112). In some embodiments, engine 200 may be hosted by a server and/or set of servers associated with cloud system 106.

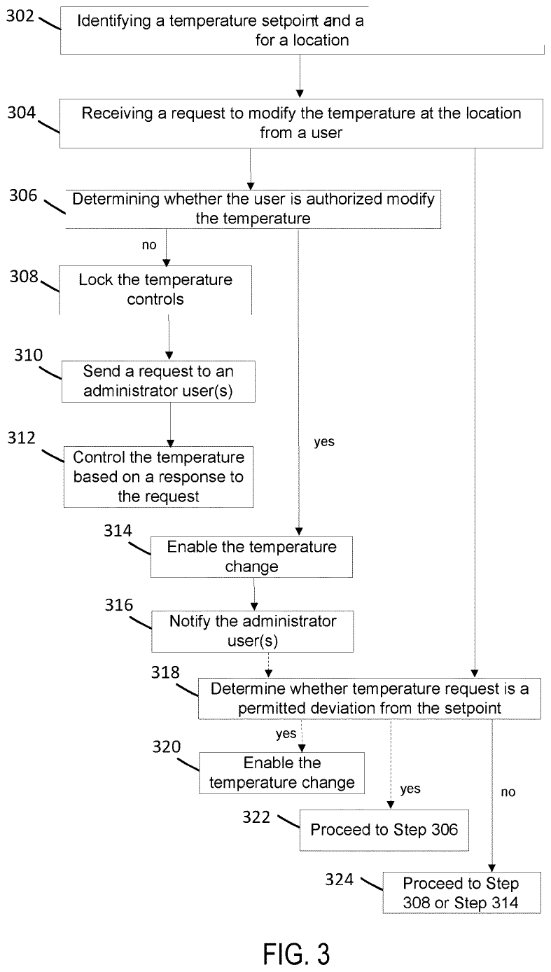

According to some embodiments, as discussed in more detail below, temperature engine 200 may be configured to implement and/or control a plurality of services and/or microservices, where each of the plurality of services/microservices are configured to execute a plurality of workflows associated with performing the disclosed temperature management. Non-limiting embodiments of such workflows are provided below in relation to at least FIG. 3.

According to some embodiments, as discussed above, temperature engine 200 may function as an application provided by cloud system 106. In some embodiments, engine 200 may function as an application installed on a server(s), network location and/or other type of network resource associated with system 106. In some embodiments, engine 200 may function as application installed and/or executing on UE 102. In some embodiments, such application may be a web-based application accessed by UE 102 and/or devices associated with sensors 110 over network 104 from cloud system 106. In some embodiments, engine 200 may be configured and/or installed as an augmenting script, program or application (e.g., a plug-in or extension) to another application or program provided by cloud system 106 and/or executing on UE 102 and/or sensors 110.

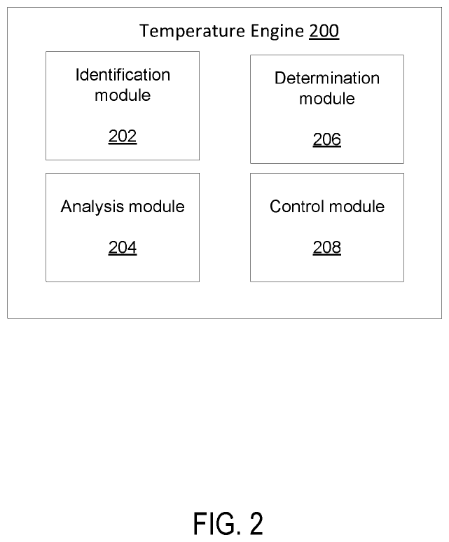

As illustrated in FIG. 2, according to some embodiments, temperature engine 200 includes identification module 202, analysis module 204, determination module 206 and control module 208. It should be understood that the engine(s) and modules discussed herein are non-exhaustive, as additional or fewer engines and/or modules (or sub-modules) may be applicable to the embodiments of the systems and methods discussed. More detail of the operations, configurations and functionalities of engine 200 and each of its modules, and their role within embodiments of the present disclosure will be discussed below.

Turning to FIG. 3, Process 300 provides non-limiting example embodiments for the disclosed temperature management framework. In some embodiments, as discussed herein, the disclosed framework provides functionality for a secure, geofenced-based control and management of a thermostat and/or an associated climate system that is associated with a location (e.g., building, house, and the like, for example). As discussed herein, the disclosed framework, via the executable steps of Process 300, enable automated and/or dynamic operational control of a location's climate system based on geofenced and requested operational values.

By way of a non-limiting example, according to some embodiments, a climate system can have an associated and defined geofence enacted at/around the perimeter of for which the climate system is associated with (e.g., property lines of a home, for example). The climate system can have an administrator user(s) (“admin” or primary user(s)), which can be, for example, the mother and father occupants of the home. The non-admin users can be the parents' child (and other any other occupants and/or visitors of the home. In this example, the mother is the only admin user.

As such, for example, the thermostat and/or manual temperature changing functionality associated with the climate system of the house can be locked when it is detected that the mother is not within the confines the home's geofence. As discussed below, this can be based on sensor data collected in/around the house (e.g., motion and/or door contact sensor data indicating the mother exited the house and left the property in her car, for example) and/or via data provided by the mother's smartphone, for example. Such locking, as discussed below, can involve the secured prevention of the thermostat's settings being manually changed without prior approval from the mother user (e.g., no changes are enabled unless explicitly enabled by the mother, upon the system detecting the mother has returned within the confines of the geofence, and/or being within a deviation range for a specific type of change).

Thus, in some embodiments, as discussed herein, the climate system is protected from unwanted, undesired and/or unnecessary climate changes from unauthorized users when the admin user is not present and/or does not authorize such actions. Among other benefits, this can result in a reduction of energy costs and a more efficient usage of real-world resources (e.g., energy) in that certain climate systems and/or operational modes can be restricted from usage when they are not deemed to need to be in use. Moreover, this can prevent unnecessary manipulations of a climate system by unauthorized users. For example, in an office building, each person working there may have different comfort levels with different temperatures; therefore, rather than enabling each user access to the keypad of the thermostat, the disclosed framework can restrict modifications to operational modes (e.g., temperature changes) when admin users (e.g., a building manager, for example) are not present and/or based on such admin users' solicited approval (e.g., via notification messages).

According to some embodiments, Steps 302-306 of Process 300 can be performed by identification module 202 of temperature engine 200; Step 308 can be performed by analysis module 204; Steps 310-312 can be performed by determination module 204; and Steps 314-318 can be performed by control module 208.

According to some embodiments, Process 300 begins with Step 302 where engine 200 identifies a temperature setpoint and a temperature geofence for a location. According to some embodiments, the setpoint and geofence can be provided by a user. In some embodiments, the setpoint can correspond to, but not be limited to, an operation mode (e.g., a scheduled heating/cooling pattern for a predetermined period of time—for example, heat the upstairs of the home from 6 AM to 8 AM to 72 degrees Fahrenheit), a setting (provided by a user or automatically determined by the system), a current temperature, an outside temperature, and the like, or some combination thereof.

In some embodiments, the geofence, and parameters associated therewith, can be based on an area associated with the location, as discussed above. The virtual perimeter set by the geofence can be, but is not limited to, provided by a user, associated with an operation mode (from the above example, the geofence can be for the upstairs of the home), sensors positioned in/around the house, location(s) of an admin user, and the like, or some combination thereof. Indeed, in some embodiments, the geofence can correspond to a time (or time period), date, type of activity occurring in the house, and the like, or some combination thereof.

For purposes of the disclosure of Process 300, by way of a non-limiting example, a geofence will be discussed in reference to a virtual perimeter around the home of a set of users (e.g., mother, father and child, for example); and, one of ordinary skill in the art would not be able to construe such non-limiting example as overly narrowing, as any shape of the virtual perimeter, time period (or duration) for which it is applied and/or activity for which it is associated with can be understood to be included in the disclosed embodiments without departing from the scope of the instant disclosure.

In Step 304, engine 200 can receive a request to modify the temperature setpoint at the location. In some embodiments, this can involve requesting to heat or cool the current temperature to a new temperature. For example, if the temperature set point is 72 degrees Fahrenheit, and the current temperature is 73 degrees Fahrenheit, the request may correspond to changing the temperature setpoint to 70 degrees Fahrenheit.

In some embodiments, the request can indicate, but is not limited to, a time period for the temperature change, particular zones within the climate system, and the like, or some combination thereof. In some embodiments, particular zones may have specifically requested temperature changes and/or corresponding time periods.

In Step 306, engine 200 can determine whether the requesting user is authorized to modify the temperature. That is, engine 200 can perform an analysis and determination as to whether the temperature setpoint can be changed from the setpoint temperature in Step 302 to the requested temperature setpoint in Step 304.

In some embodiments, Step 306 can involve determining whether the request originated from an admin user and/or a device of an admin user. In some embodiments, such determination can involve parsing the request, and extracting an identifier (ID) associated with the user of the request, and determining if the ID corresponds to an admin user.

In some embodiments, such determination can involve detecting a current location of the admin user at a time of the request in Step 304. According to some embodiments, identifying a current location of an admin user can involve collecting sensor data from at least a portion of the sensors at the location, and determining whether the admin user is detected. In some embodiments, engine 200 can ping the device (e.g., smartphone) of the admin user, and upon receiving a response, determine a location of the user (e.g., provided via GPS data, for example). In some embodiments, engine 200 can determine, verify, confirm and/or identify whether the admin user has been identified as exiting the geofence and not returning, whereby such identification can be performed via the sensor data from the location. For example, has captured and analyzed imagery from a camera at the location (e.g., analyzed via an applied facial recognition and/or computer vision algorithm) indicated the admin user exiting the location and moving outside the bounds of the geofence.

According to some embodiments, Step 306 can involve collecting sensor data from a predetermined period of time prior to the request of Step 304 (e.g., the last 12 hours, for example), and performing a computational analysis of such sensor data to determine whether the admin user has been identified as being within the confines of the geofence. According to some embodiments, engine 200 can implement any type of known or to be known computational analysis technique, algorithm, mechanism or technology to analyze the collected sensor data.

In some embodiments, engine 200 may include a specific trained artificial intelligence/machine learning model (AI/ML), a particular machine learning model architecture, a particular machine learning model type (e.g., convolutional neural network (CNN), recurrent neural network (RNN), autoencoder, support vector machine (SVM), and the like), or any other suitable definition of a machine learning model or any suitable combination thereof.

In some embodiments, engine 200 may be configured to utilize one or more AI/ML techniques chosen from, but not limited to, computer vision, feature vector analysis, decision trees, boosting, support-vector machines, neural networks, nearest neighbor algorithms, Naive Bayes, bagging, random forests, logistic regression, and the like. By way of a non-limiting example, engine 200 can implement an XGBoost algorithm for regression and/or classification to analyze the sensor data, as discussed herein.

According to some embodiments and, optionally, in combination of any embodiment described above or below, a neutral network technique may be one of, without limitation, feedforward neural network, radial basis function network, recurrent neural network, convolutional network (e.g., U-net) or other suitable network. In some embodiments and, optionally, in combination of any embodiment described above or below, an implementation of Neural Network may be executed as follows:
a. define Neural Network architecture/model,
b. transfer the input data to the neural network model,
c. train the model incrementally,
d. determine the accuracy for a specific number of timesteps,
e. apply the trained model to process the newly-received input data,
f. optionally and in parallel, continue to train the trained model with a predetermined periodicity.

In some embodiments and, optionally, in combination of any embodiment described above or below, the trained neural network model may specify a neural network by at least a neural network topology, a series of activation functions, and connection weights. For example, the topology of a neural network may include a configuration of nodes of the neural network and connections between such nodes. In some embodiments and, optionally, in combination of any embodiment described above or below, the trained neural network model may also be specified to include other parameters, including but not limited to, bias values/functions and/or aggregation functions. For example, an activation function of a node may be a step function, sine function, continuous or piecewise linear function, sigmoid function, hyperbolic tangent function, or other type of mathematical function that represents a threshold at which the node is activated. In some embodiments and, optionally, in combination of any embodiment described above or below, the aggregation function may be a mathematical function that combines (e.g., sum, product, and the like) input signals to the node. In some embodiments and, optionally, in combination of any embodiment described above or below, an output of the aggregation function may be used as input to the activation function. In some embodiments and, optionally, in combination of any embodiment described above or below, the bias may be a constant value or function that may be used by the aggregation function and/or the activation function to make the node more or less likely to be activated.

In some embodiments, when engine 200 determines that an admin user is within the geofence, Process 300 may halt, and monitoring of the location for further requests via Step 304 can be recursively performed.

According to some embodiments, when engine 200 determines that the admin user is physically located outside the confines of the geofence, it is determined that the requesting user is not authorized to modify the temperature setpoint (and the request from Step 304 is denied). As such, Process 300 can proceed from Step 306 to Step 308, where engine 200 can lock the temperature controls of the thermostat. For example, controls of a thermostat may be restricted from being accessed (e.g., changes to temperature settings, operation modes, and the like, can be restricted from being entered. In some embodiments, such locking can involve setting a predetermined range for an operation mode. For example, for a cooling operation mode, a range of 70-77 degrees Fahrenheit may be set; and, similarly, for a heating operation mode, a range of 68-72 degrees Fahrenheit may be set. As such, in some embodiments, locking may restrict an amount or value according to a range of temperature values, which may correspond to or be based on a type of operation mode (e.g., which mode must be enabled to achieve the requested temperature respective to a current temperature and/or temperature setpoint).

According to some embodiments, such locking can be according to a predetermined period of time; and in some embodiments, the locking may still enable emergency actions to be taken (e.g., shut off system upon detection of an emergency, for example, should sensor data indicate a fire has occurred at the location, the on/off switch for the thermostat may be enabled (and in some embodiments, may auto-shut off without user input)).

According to some embodiments, Step 308 can involve engine 200 sending instructions to the controls of the thermostat that modify their read/write values. This can be stored in database 108. Such instructions can be automatically sent and received by the thermostat, whereby the instructions act an override to conflicting operations currently executing.

In Step 310, upon locking the temperature controls, engine 200 can generate and send an electronic message request to a device of the admin user. In some embodiments, the request can be in any type of known or to be known message format, including, for example, an SMS message, email, notification message provided via an associated climate application executing on the admin user's device, and the like, or some combination thereof.

In some embodiments, the request message can be compiled to include interactive information that enables the admin user to accept, deny and/or modify the requested temperature setpoint. In some embodiments, the request message can correspond to a time period and/or particular zone within the climate system for which the approval, denial and/or modification can occur. For example, the admin user may approve the temperature setpoint change for 6 hours and only for Zone 1 of the three climate zones in the house (as opposed to all three zones indicated in the request).

In some embodiments, the options for feedback provided within the request message can be provided via selectable interface objects (IOs) and/or input entry areas (e.g., text entry, voice entry, and the like, for example). In some embodiments, request message can include information about the current temperature, temperature setpoint (from Step 302) and the requested temperature setpoint (from Step 304). In some embodiments, the request message may require authentication for the admin user to access (e.g., two-factor, username/password, biometrics, PIN, and the like, or some combination thereof).

In Step 312, engine 200 functions to the control the temperature setpoint based on input provided by the admin user in response to the message request from Step 310. In some embodiments, for example, if the admin user provides feedback or a response message that the temperature setpoint change is approved, then engine 200 can automatically function to modify the temperature setpoint (from Step 302) to the temperature setpoint requested in Step 304.

In some embodiments, if the request is denied by the admin user, a notification can be sent to the thermostat to ignore and/or decline the request for the setpoint change.

In some embodiments, if the admin user provides a modified temperature setpoint, engine 200 can function to automatically modify the temperature setpoint according to the setpoint value provided by the admin user. For example, if the request corresponded to changing the temperature setpoint to 70 degrees Fahrenheit from 72 degrees Fahrenheit, and the admin user “approved” a change to 71 degrees Fahrenheit, engine 200 can function to modify the thermostat's temperature setpoint to 71 degrees Fahrenheit.

In some embodiments, the temperature control engine 200 performs via Step 312 can be based on whether the temperature setpoint change falls within a threshold, deviation or limit, as discussed below at least in relation to Step 318.

Turning back to Step 306, when engine 200 determines that the admin user is located within the geofence and/or the user providing the request from Step 304 is approved (e.g., is the admin user, or in some embodiments, a delegated user by the admin user, for example), Process 300 can proceed from Step 306 to Step 314. In Step 314, engine 200 can function to enable the temperature change. This can be performed in a similar manner as discussed above in relation to the approval from Step 312.

In some embodiments, engine 200 can further perform Step 316 where a notification message can be sent to the admin user alerting them to the temperature change. In some embodiments, such notification message may include optional feedback similar to the IOs from Step 310, whereby the admin user may be enabled to provide feedback as to the automated and performed temperature setpoint change.

According to some embodiments, as mentioned above, the temperature setpoint change can also be subject to analysis as to whether the temperature request falls within a permitted deviations (or threshold or limit, used interchangeably), as in Step 318. In some embodiments, the operation of Step 318 can be performed after Step 316, prior to Step 306 and in parallel with Steps 306-316. Thus, for example, Step 318's determination can be performed prior to determining whether the admin user is within the geofence (e.g., via Steps 306-316). In another example, Step 318 can be performed upon determining whether a temperature setpoint change is approved (e.g., Step 312 or Step 314).

Accordingly, in Step 318, engine 200 can determine whether temperature setpoint change is permitted based on the difference value from the current temperature setpoint. According to some embodiments, the deviation/threshold/limit can be a predetermined number or a dynamically determined value, which can be provided by or based on, but not limited to, a value provided by the admin user, a previous setpoint temperature value, a type and/or status of an operation mode, weather outside the location (e.g., what is the outside temperature, and is there any precipitation, cloud cover, and the like), and the like, or some combination thereof.

In some embodiments, when the temperature setpoint change value falls within (e.g., equal to or less than) the deviation/threshold amount, Process 300 can proceed from Step 318 to Step 320, where the temperature change is enabled via engine 200 functioning to modify the temperature setpoint change according to the value in Step 304.

In some embodiments, Process can proceed to Step 322, whereby an approved value according to the threshold amount can be provided for analysis as to whether the admin user is within the geofence, as discussed above.

In some embodiments, when the temperature setpoint change value is greater than the threshold temperature (or temperature change limit), engine 200 can perform Step 324, whereby processing can proceed to Step 308, whereby the thermostat may be locked, whereby the admin user can be solicited for feedback, as discussed above.

In some embodiments, Step 324 can involve engine 200 proceeding to Step 314, whereby the a temperature change can be enabled; however, since the temperature set point change value is greater than the threshold, engine 200 can modify the change value to the maximum under the threshold temperature, which engine 200 can then set the thermostat to. For example, if the current temperature setpoint is 70 degrees Fahrenheit, the requested temperature set point is 73 degrees Fahrenheit, and the threshold temperature is 71 degrees Fahrenheit, engine 200 can modify the temperature change request to the threshold temperature and set the thermostat accordingly.

In some embodiments, as discussed above, upon performing Steps 320, 322 or 324, processing can conclude (in embodiments where Step 306 was performed prior to Step 318), or can proceed to Step 306.

Thus, as discussed herein, the disclosed framework can enable an automated and/or dynamic operational control of a climate system based on geofenced and current and/or requested operational values.

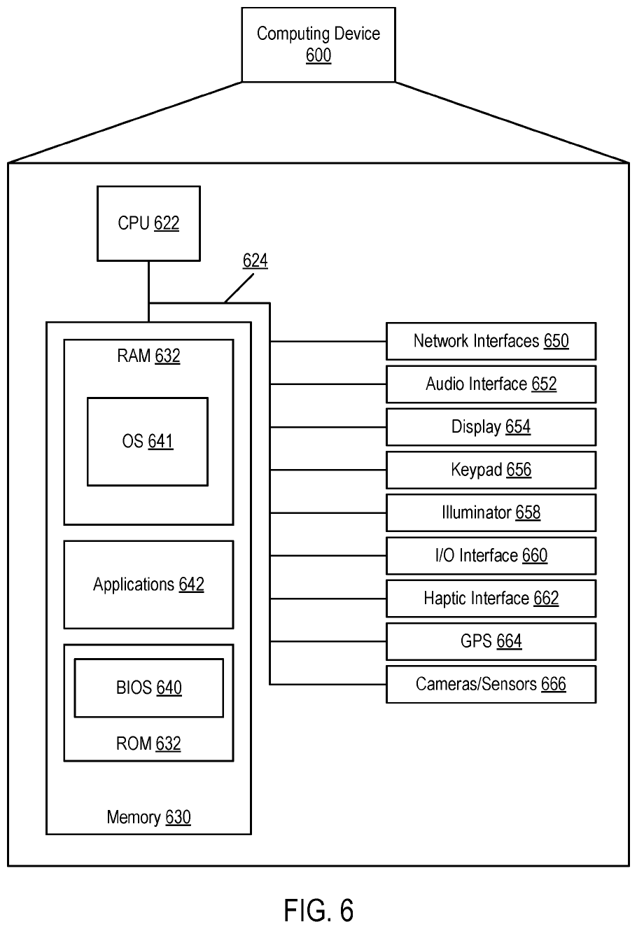

FIG. 6 is a schematic diagram illustrating a client device showing an example embodiment of a client device that may be used within the present disclosure. Client device 600 may include many more or less components than those shown in FIG. 6. However, the components shown are sufficient to disclose an illustrative embodiment for implementing the present disclosure. Client device 600 may represent, for example, UE 102 discussed above at least in relation to FIG. 1.

As shown in the figure, in some embodiments, Client device 600 includes a processing unit (CPU) 622 in communication with a mass memory 630 via a bus 624. Client device 600 also includes a power supply 626, one or more network interfaces 650, an audio interface 652, a display 654, a keypad 656, an illuminator 658, an input/output interface 660, a haptic interface 662, an optional global positioning systems (GPS) receiver 664 and a camera(s) or other optical, thermal or electromagnetic sensors 666. Device 600 can include one camera/sensor 666, or a plurality of cameras/sensors 666, as understood by those of skill in the art. Power supply 626 provides power to Client device 600.

Client device 600 may optionally communicate with a base station (not shown), or directly with another computing device. In some embodiments, network interface 650 is sometimes known as a transceiver, transceiving device, or network interface card (NIC).

Audio interface 652 is arranged to produce and receive audio signals such as the sound of a human voice in some embodiments. Display 654 may be a liquid crystal display (LCD), gas plasma, light emitting diode (LED), or any other type of display used with a computing device. Display 654 may also include a touch sensitive screen arranged to receive input from an object such as a stylus or a digit from a human hand.

Keypad 656 may include any input device arranged to receive input from a user. Illuminator 658 may provide a status indication and/or provide light.

Client device 600 also includes input/output interface 660 for communicating with external. Input/output interface 660 can utilize one or more communication technologies, such as USB, infrared, Bluetooth™, or the like in some embodiments. Haptic interface 662 is arranged to provide tactile feedback to a user of the client device.

Optional GPS transceiver 664 can determine the physical coordinates of Client device 600 on the surface of the Earth, which typically outputs a location as latitude and longitude values. GPS transceiver 664 can also employ other geo-positioning mechanisms, including, but not limited to, triangulation, assisted GPS (AGPS), E-OTD, CI, SAI, ETA, BSS or the like, to further determine the physical location of client device 600 on the surface of the Earth. In one embodiment, however, Client device may through other components, provide other information that may be employed to determine a physical location of the device, including for example, a MAC address, Internet Protocol (IP) address, or the like.

Mass memory 630 includes a RAM 632, a ROM 634, and other storage means. Mass memory 630 illustrates another example of computer storage media for storage of information such as computer readable instructions, data structures, program modules or other data. Mass memory 630 stores a basic input/output system (“BIOS”) 640 for controlling low-level operation of Client device 600. The mass memory also stores an operating system 641 for controlling the operation of Client device 600.

Memory 630 further includes one or more data stores, which can be utilized by Client device 600 to store, among other things, applications 642 and/or other information or data. For example, data stores may be employed to store information that describes various capabilities of Client device 600. The information may then be provided to another device based on any of a variety of events, including being sent as part of a header (e.g., index file of the HLS stream) during a communication, sent upon request, or the like. At least a portion of the capability information may also be stored on a disk drive or other storage medium (not shown) within Client device 600.

Applications 642 may include computer executable instructions which, when executed by Client device 600, transmit, receive, and/or otherwise process audio, video, images, and enable telecommunication with a server and/or another user of another client device. Applications 642 may further include a client that is configured to send, to receive, and/or to otherwise process gaming, goods/services and/or other forms of data, messages and content hosted and provided by the platform associated with engine 200 and its affiliates.

As used herein, the terms “computer engine” and “engine” identify at least one software component and/or a combination of at least one software component and at least one hardware component which are designed/programmed/configured to manage/control other software and/or hardware components (such as the libraries, software development kits (SDKs), objects, and the like).

Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. In some embodiments, the one or more processors may be implemented as a Complex Instruction Set Computer (CISC) or Reduced Instruction Set Computer (RISC) processors; x86 instruction set compatible processors, multi-core, or any other microprocessor or central processing unit (CPU). In various implementations, the one or more processors may be dual-core processor(s), dual-core mobile processor(s), and so forth.

Computer-related systems, computer systems, and systems, as used herein, include any combination of hardware and software. Examples of software may include software components, programs, applications, operating system software, middleware, firmware, software modules, routines, subroutines, functions, methods, procedures, software interfaces, API, instruction sets, computer code, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

For the purposes of this disclosure a module is a software, hardware, or firmware (or combinations thereof) system, process or functionality, or component thereof, that performs or facilitates the processes, features, and/or functions described herein (with or without human interaction or augmentation). A module can include sub-modules. Software components of a module may be stored on a computer readable medium for execution by a processor. Modules may be integral to one or more servers, or be loaded and executed by one or more servers. One or more modules may be grouped into an engine or an application.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores,” may be stored on a tangible, machine readable medium and supplied to various customers or manufacturing facilities to load into the fabrication machines that make the logic or processor. Of note, various embodiments described herein may, of course, be implemented using any appropriate hardware and/or computing software languages (e.g., C++, Objective-C, Swift, Java, Javascript, Python, Perl, QT, and the like).

For example, exemplary software specifically programmed in accordance with one or more principles of the present disclosure may be downloadable from a network, for example, a website, as a stand-alone product or as an add-in package for installation in an existing software application. For example, exemplary software specifically programmed in accordance with one or more principles of the present disclosure may also be available as a client-server software application, or as a web-enabled software application. For example, exemplary software specifically programmed in accordance with one or more principles of the present disclosure may also be embodied as a software package installed on a hardware device.

For the purposes of this disclosure the term “user”, “subscriber” “consumer” or “customer” should be understood to refer to a user of an application or applications as described herein and/or a consumer of data supplied by a data provider. By way of example, and not limitation, the term “user” or “subscriber” can refer to a person who receives data provided by the data or service provider over the Internet in a browser session, or can refer to an automated software application which receives the data and stores or processes the data. Those skilled in the art will recognize that the methods and systems of the present disclosure may be implemented in many manners and as such are not to be limited by the foregoing exemplary embodiments and examples. In other words, functional elements being performed by single or multiple components, in various combinations of hardware and software or firmware, and individual functions, may be distributed among software applications at either the client level or server level or both. In this regard, any number of the features of the different embodiments described herein may be combined into single or multiple embodiments, and alternate embodiments having fewer than, or more than, all of the features described herein are possible.

Functionality may also be, in whole or in part, distributed among multiple components, in manners now known or to become known. Thus, myriad software/hardware/firmware combinations are possible in achieving the functions, features, interfaces and preferences described herein. Moreover, the scope of the present disclosure covers conventionally known manners for carrying out the described features and functions and interfaces, as well as those variations and modifications that may be made to the hardware or software or firmware components described herein as would be understood by those skilled in the art now and hereafter.

Furthermore, the embodiments of methods presented and described as flowcharts in this disclosure are provided by way of example in order to provide a more complete understanding of the technology. The disclosed methods are not limited to the operations and logical flow presented herein. Alternative embodiments are contemplated in which the order of the various operations is altered and in which sub-operations described as being part of a larger operation are performed independently.

While various embodiments have been described for purposes of this disclosure, such embodiments should not be deemed to limit the teaching of this disclosure to those embodiments. Various changes and modifications may be made to the elements and operations described above to obtain a result that remains within the scope of the systems and processes described in this disclosure.

What is claimed is:

1. A method comprising:
identifying, by a device, a temperature setpoint for a location provided by a first user, the temperature setpoint corresponding to a predetermined climate-control system is to maintain at the location, the first user having write access to temperature controls of the climate system;
detecting, by the device, a request from a second user, the request comprising information related to a temperature change from the temperature setpoint to another temperature;
identifying, by the device, a geofence associated with the location; and
determining, by the device, whether the first user is currently positioned within bounds of the geofence,
when the first user is determined to be outside the geofence, locking the temperature controls of the climate-control system, and automatically communicating a request to a device of the first user, the request comprising options for the first user to accept or deny the request from the second user, and
when the first user is determined to be inside the geofence, enabling the temperature change, and automatically communicating a notification to the device of the first user indicating the temperature change, the notification further comprising functionality enabling the first user to modify the temperature change.

2. The method of claim 1, further comprising:
determining whether the temperature change corresponds to a temperature change limit set by the first user,
when the temperature change is equal to or less than the temperature change limit, automatically enabling the temperature change, and
when the temperature change is greater of the temperature change limit, communicating the request to the device of the first user.

3. The method of claim 2, further comprising:
modifying a value of the temperature change according to a value of the temperature change limit; and
enabling the modified temperature change.

4. The method of claim 1, wherein the options for the first user further comprise options to modify the temperature change.

5. The method of claim 1, wherein the options for the first user further comprise options to set a time period for the temperature change.

6. The method of claim 1, further comprising:
collecting, based on a time associated with the request, sensor data associated with the location; and
analyzing the collected sensor data, wherein the determination of whether the first user is within the bounds of the geofence is based on the sensor data analysis.

7. The method of claim 1, further comprising:
detecting, in response to the request, a location of a device of the first user, wherein the determination of whether the first user is within the bounds of the geofence is based on the location of the first user device respective to the bounds of the geofence.

8. The method of claim 1, wherein the geofence comprises a virtual perimeter associated with at least a portion of boundaries of the location.

9. The method of claim 1, wherein the geofence is associated with specific portions of the location, wherein the location comprises a plurality of geofences respective to a plurality of areas within the location.

10. The method of claim 1, wherein the climate-control system is at least one of a heating, ventilation and air conditioning (HVAC) and baseboard system.

11. A device comprising:
a processor configured to:
identify a temperature setpoint for a location provided by a first user, the temperature setpoint corresponding to a predetermined temperature a climate-control system is to maintain at the location, the first user having write access to temperature controls of the climate-control system;
detect a request from a second user, the request comprising information related to a temperature change from the temperature setpoint to another temperature;
identify a geofence associated with the location; and
determine whether the first user is currently positioned within bounds of the geofence,
when the first user is determined to be outside the geofence, lock the temperature controls of the climate-control system, and automatically communicate a request to a device of the first user, the request comprising options for the first user to accept or deny the request from the second user, and
when the first user is determined to be inside the geofence, enable the temperature change, and automatically communicate a notification to the device of the first user indicating the temperature change, the notification further comprising functionality enabling the first user to modify the temperature change.

12. The device of claim 11, wherein the processor is further configured to:
determine whether the temperature change corresponds to a temperature change limit set by the first user,
when the temperature change is equal to or less than the temperature change limit, automatically enable the temperature change, and
when the temperature change is greater of the temperature change limit, communicate the request to the device of the first user 13. The device of claim 12, wherein the processor is further configured to:
modify a value of the temperature change according to a value of the temperature change limit; and
enable the modified temperature change.

14. The device of claim 11, wherein the processor is further configured to:
collect, based on a time associated with the request, sensor data associated with the location; and
analyze the collected sensor data, wherein the determination of whether the first user is within the bounds of the geofence is based on the sensor data analysis.

15. The device of claim 11, wherein the processor is further configured to:
detect, in response to the request, a location of a device of the first user, wherein the determination of whether the first user is within the bounds of the geofence is based on the location of the first user device respective to the bounds of the geofence.

16. A non-transitory computer-readable storage medium tangibly encoded with computer-executable instructions that when executed by a device, perform a method comprising:
identifying, by the device, a temperature setpoint for a location provided by a first user, the temperature setpoint corresponding to a predetermined temperature a climate-control system is to maintain at the location, the first user having write access to temperature controls of the climate-control system;
detecting, by the device, a request from a second user, the request comprising information related to a temperature change from the temperature setpoint to another temperature;
identifying, by the device, a geofence associated with the location; and
determining, by the device, whether the first user is currently positioned within bounds of the geofence,
when the first user is determined to be outside the geofence, locking the temperature controls of the climate-control system, and automatically communicating a request to a device of the first user, the request comprising options for the first user to accept or deny the request from the second user, and
when the first user is determined to be inside the geofence, enabling the temperature change, and automatically communicating a notification to the device of the first user indicating the temperature change, the notification further comprising functionality enabling the first user to modify the temperature change.

17. The non-transitory computer-readable storage medium of claim 16, further comprising:
determining whether the temperature change corresponds to a temperature change limit set by the first user,
when the temperature change is equal to or less than the temperature change limit, automatically enabling the temperature change, and
when the temperature change is greater of the temperature change limit, communicating the request to the device of the first user 18. The non-transitory computer-readable storage medium of claim 17, further comprising:
modifying a value of the temperature change according to a value of the temperature change limit; and
enabling the modified temperature change.

19. The non-transitory computer-readable storage medium of claim 16, further comprising:
collecting, based on a time associated with the request, sensor data associated with the location; and
analyzing the collected sensor data, wherein the determination of whether the first user is within the bounds of the geofence is based on the sensor data analysis.

20. The non-transitory computer-readable storage medium of claim 16, further comprising:
detecting, in response to the request, a location of a device of the first user, wherein the determination of whether the first user is within the bounds of the geofence is based on the location of the first user device respective to the bounds of the geofence.
